(19) United States
(12) Patent Application Publication
(10) Pub. No.: US 2024/0333085 A1
(43) Pub. Date: Oct. 3, 2024

(54) ROTARY ELECTRIC MACHINE AND MANUFACTURING METHOD OF ROTARY ELECTRIC MACHINE

(71) Applicants: Nidec Corporation, Kyoto (JP); Nidec Mobility Corporation, Komaki (JP)

(72) Inventors: Takashi HATTORI, Kyoto (JP); Yoshinobu ARAO, Kyoto (JP); Kenta SEKI, Kyoto (JP); Masamitsu HAMASAKI, Komaki (JP); Shinichi TOGAWA, Komaki (JP); Takeshi YASUDA, Komaki (JP)

(21) Appl. No.: 18/621,206

(22) Filed: Mar. 29, 2024

(30) Foreign Application Priority Data
Mar. 31, 2023 (JP) 2023-057146

(51) Int. Cl. H02K 5/22; H02K 5/10; H02K 15/00

(52) U.S. Cl. CPC H02K 5/225; H02K 5/10; H02K 15/00; H02K 2203/03

(57) ABSTRACT

A rotary electric machine includes a housing having a tubular shape extending in a first direction and including an opening that opens to one side in the first direction, a first board on one side in a second direction intersecting the first direction with respect to the housing, and a lid fixed to an end portion on one side in the first direction of the housing. The housing includes a through hole penetrating the housing in the second direction. The lid includes a connector including a first terminal and a holder to hold the first terminal, and a cover that covers the opening and holder and is defined by a same structure as that of the holder.

### CROSS-REFERENCE TO RELATED APPLICATIONS

The present application claims priority under 35 U.S.C. § 119 to Japanese Patent Application No. 2023-057146, filed on Mar. 31, 2023, the entire contents of which are hereby incorporated herein by reference.

### 1. FIELD OF THE INVENTION

The present disclosure relates to a rotary electric machine and a manufacturing method of the rotary electric machine.

### 2. BACKGROUND

There is a known electric motor having a configuration in which a control unit including a circuit board is disposed radially outside a housing internally accommodating a motor unit.

When the above-described electric motor includes a connector to be connected to the circuit board inside the housing, there is a problem that an assembly process of attaching the connector to the housing becomes complicated depending on the orientation of the connector and the circuit board.

### SUMMARY

One example embodiment of a rotary electric machine of the present disclosure includes a housing having a tubular shape extending in a first direction and including an opening that opens to one side in the first direction, a first board located on one side in a second direction intersecting the first direction with respect to the housing, and a lid fixed to an end portion on one side in the first direction of the housing. The housing includes a through hole penetrating the housing in the second direction. The lid includes a connector including a first terminal and a holder to hold the first terminal, and a cover that covers the opening and provided using a same structure as the holder. The first terminal includes a first extending portion extending in the first direction and held by the holder, and a second extending portion extending in the second direction, passing through the through hole in the second direction, and connected to the first board. A portion opposing the through hole in the second direction of the end portion on one side in the first direction of the housing is positioned on another side in the first direction relative to an end portion on one side in the first direction of the through hole.

One example embodiment of a manufacturing method of a rotary electric machine of the present disclosure includes a housing having a tubular shape extending in a first direction and including an opening that opens to one side in the first direction, a first board located on one side in a second direction intersecting the first direction relative to the housing, and a lid fixed to an end portion on one side in the first direction of the housing. The housing includes a through hole penetrating the housing in the second direction. The lid includes a connector including a first terminal and a holder to hold the first terminal, and a cover that covers the opening and formed using a same structure as the holder. The first terminal includes a first extending portion extending in the first direction and held by the holder, and a second extending portion extending in the second direction, passing through the through hole in the second direction, and connected to the first board. A manufacturing method of a rotary electric machine in which a portion opposing the through hole in the second direction of the end portion on one side in the first direction of the housing is positioned on another side in the first direction relative to an end portion on one side in the first direction of the through hole preferably includes a first process of moving the connector and the cover from another side in the second direction of the housing to one side in the second direction to pass the second extending portion through the through hole, and a second process of connecting the second extending portion to the first board.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view illustrating a rotary electric machine of an example embodiment of the present invention.

FIG. 2 is a perspective view illustrating a portion of a rotary electric machine of an example embodiment of the present invention.

FIG. 3 is a perspective view illustrating a portion of a housing of an example embodiment of the present invention.

FIG. 4 is a perspective view illustrating a lid of an example embodiment of the present invention.

FIG. 5 is a first cross-sectional view illustrating a manufacturing method of a rotary electric machine according to an example embodiment of the present invention.

FIG. 6 is a second cross-sectional view illustrating a

manufacturing method of a rotary electric machine according to an example embodiment of the present invention.

FIG. 7 is a second cross-sectional view illustrating a manufacturing method of a rotary electric machine of an example embodiment of the present invention.

### DETAILED DESCRIPTION

Hereinafter, rotary electric machines and manufacturing methods of rotary electric machines according to example embodiments of the present disclosure will be described with reference to the drawings. Note that the scope of the present disclosure is not limited to the example embodiments described below, but can be modified optionally within the scope of the technical ideas of the present disclosure. There is a case where scales, numbers, and the like of structures illustrated in the following drawings may differ from those of actual structures, for the sake of easier understanding of the structures.

A first direction D1 illustrated in each drawing is a direction in which the housing of the rotary electric machine of the present example embodiment extends. In the present example embodiment, the first direction D1 is a vertical direction. In the following description, a side on which an arrow in the first direction D1 is pointed (+D1 side) is called “upper side” or “one side in the first direction D1”, and a side opposite to the side on which the arrow in the first direction D1 is pointed (−D1 side) is called “lower side” or “other side in the first direction D1”.

A second direction D2 illustrated in each drawing is a direction intersecting the first direction D1. In the present example embodiment, the second direction D2 is a direction orthogonal to the first direction D1. In the following description, a side on which an arrow in the second direction D2 is pointed (+D2 side) is called “one side in the second direction D2”, and a side opposite to the side on which the arrow in the second direction D2 is pointed (−D2 side) is called “other side in the second direction D2”.

A third direction D3 illustrated in each drawing is a direction orthogonal to both the first direction D1 and the second direction D2. In the following description, a side on which an arrow in the third direction D3 is pointed (+D3 side) is called “one side in the third direction D3”, and a side opposite to the side on which the arrow in the third direction D3 is pointed (−D3 side) is called “other side in the third direction D3”.

A central axis J illustrated in each drawing is an imaginary axis extending in the first direction D1. In the following description, a radial direction about the central axis J is simply called “radial direction”, and a circumferential direction about central the axis J is simply called “circumferential direction”. The circumferential direction is indicated by an arrow θ in each drawing. In the following description, a side on which the arrow θ is pointed (+θ side) in the circumferential direction is called “one side in the circumferential direction”, and a side opposite to the side on which the arrow θ is pointed (−θ side) in the circumferential direction is called “other side in the circumferential direction”. One side in the circumferential direction is a side that advances clockwise around the central axis J as viewed from the upper side (+D1 side). The other side in the circumferential direction is a side that advances counterclockwise around the central axis J as viewed from the upper side (+D1 side).

In the present description, “loop” may assume any shape as long as it extends continuously over the entire circumference, and may be an annular loop, may be a polygonal loop, or may be a shape having a part extending in a curved shape and a part extending in a linear shape.

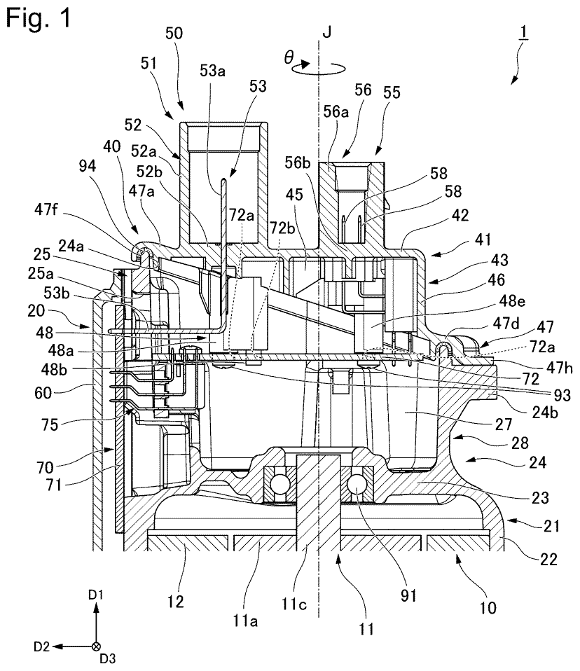

A rotary electric machine 1 of the present example embodiment illustrated in FIG. 1 is a motor mounted on an electric power steering system of a vehicle, for example. The rotary electric machine 1 is an electromechanical motor. The rotary electric machine 1 includes a motor unit 10, a case 20, and a control unit 70.

The motor unit 10 includes a rotor 11 and a stator 12. The rotor 11 is rotatable about the central axis J. The rotor 11 includes a rotor core 11a having an annular loop about the central axis J, a shaft 11c having a cylindrical shape extending in the first direction D1 about the central axis J, and a magnet not illustrated. The shaft 11c passes through the inside of the rotor core 11a in the first direction D1. The shaft 11c is fixed to the rotor core 11a. The magnet not illustrated is fixed to the rotor core 11a. The stator 12 has a loop surrounding the rotor 11. The stator 12 is disposed radially outside the rotor 11.

The case 20 internally accommodates the motor unit 10 and the control unit 70. The case 20 includes a housing 21, a lid portion 40, and a board cover member 60.

The housing 21 internally accommodates a part of the motor unit 10 and the control unit 70. The housing 21 has a tubular shape extending in the first direction D1. The housing 21 surrounds the central axis J. In the present example embodiment, the housing 21 is made of metal. The housing 21 may be made of resin. As illustrated in FIG. 1, the housing 21 includes a motor accommodation portion 22, a bearing holder 23, and a peripheral wall portion 24.

The motor accommodation portion 22 has a tubular shape extending in the first direction D1. The motor accommodation portion 22 surrounds the central axis J. The motor unit 10 is accommodated inside the motor accommodation portion 22. The stator 12 is fixed to an inner peripheral surface of the motor accommodation portion 22. The bearing holder 23 has a substantially annular loop protruding radially inward from the upper end of the motor accommodation portion 22. As viewed in the first direction D1, the inner peripheral surface of the bearing holder 23 has a circular shape about the central axis J. A bearing 91 is held on the inner peripheral surface of the bearing holder 23. The bearing 91 rotatably supports the shaft 11c about the central axis J. This makes the rotor 11 rotatable about the central axis J.

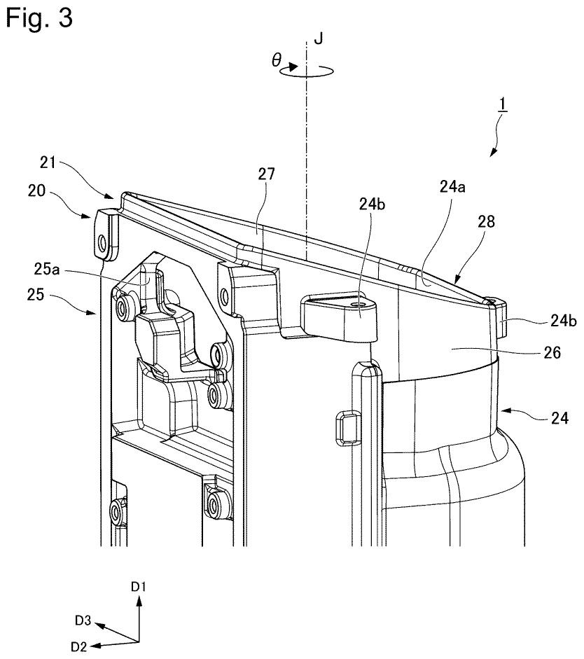

As illustrated in FIG. 3, the peripheral wall portion 24 has a tubular shape extending upward from the upper end of the motor accommodation portion 22. The peripheral wall portion 24 surrounds the central axis J. A part of the control unit 70 is accommodated inside the peripheral wall portion 24. The peripheral wall portion 24 includes an opening portion 24a, a first protrusion portion 24b, a first peripheral wall portion 25, a second peripheral wall portion 26, a third peripheral wall portion 27, and a fourth peripheral wall portion 28. The first peripheral wall portion 25 and the fourth peripheral wall portion 28 face each other in the second direction D2. The second peripheral wall portion 26 and the third peripheral wall portion 27 face each other in the third direction D3. The opening portion 24a opens upward, that is, on one side (+D1 side) in the first direction D1. The inside of the peripheral wall portion 24 and the inside of the lid portion 40 are connected through the opening portion 24a.

The first peripheral wall portion 25 is a part on one side (+D2 side) in the second direction D2 of the peripheral wall portion 24. The first peripheral wall portion 25 has a plate shape extending in the first direction D1. The plate surface of the first peripheral wall portion 25 faces the second direction D2. As viewed in the second direction D2, the first peripheral wall portion 25 has a substantially rectangular shape whose long side extends in the first direction D1. The first peripheral wall portion 25 is provided with a through hole 25a. The through hole 25a is a hole penetrating the first peripheral wall portion 25 in the second direction D2. That is, the housing 21 has the through hole 25a penetrating the housing 21 in the second direction D2. As illustrated in FIG. 1, the inside of the peripheral wall portion 24 and the inside of the board cover member 60 are connected through the through hole 25a.

As illustrated in FIG. 3, the second peripheral wall portion 26 is a part on the other side (−D3 side) in the third direction D3 of the peripheral wall portion 24. The third peripheral wall portion 27 is a part on one side (+D3 side) in the third direction D3 of the peripheral wall portion 24. As viewed in the first direction D1, a part on one side (+D2 side) in the second direction D2 of each of the second peripheral wall portion 26 and the third peripheral wall portion 27 has a linear shape extending in the second direction D2. As viewed in the first direction D1, a part on the other side (−D2 side) in the second direction D2 of each of the second peripheral wall portion 26 and the third peripheral wall portion 27 has a substantially arc shape convex outward in the radial direction. The upper end of each of the second peripheral wall portion 26 and the third peripheral wall portion 27 is positioned downward from one side in the second direction D2 toward the other side in the second direction D2. That is, the upper end, that is, the end portion on one side (+D1 side) in the first direction D1 of the housing 21 is positioned downward, that is, on the other side (−D1 side) in the first direction D1 from one side in the second direction D2 toward the other side in the second direction D2. In the present example embodiment, as viewed in the third direction D3, the upper end of the housing 21 is linearly inclined so as to be positioned downward from one side in the second direction D2 toward the other side in the second direction D2. As viewed in the third direction D3, the upper end of the housing may be positioned downward in a curved shape from one side in the second direction D2 toward the other side in the second direction D2. As viewed in the third direction D3, the upper end of the housing may have a shape formed by a curve and a plurality of straight lines.

The fourth peripheral wall portion 28 is a part on the other side (−D2 side) in the second direction D2 of the peripheral wall portion 24. As viewed in the first direction D1, the fourth peripheral wall portion 28 has a substantially linear shape extending in the third direction D3. The upper end of the fourth peripheral wall portion 28 is connected to the upper ends of the second peripheral wall portion 26 and the third peripheral wall portion 27. The fourth peripheral wall portion 28 faces the through hole 25a in the second direction D2. As illustrated in FIG. 1, in the first direction D1, the upper end of the fourth peripheral wall portion 28 is positioned lower than the upper end of the first peripheral wall portion 25. In the first direction D1, the upper end of the fourth peripheral wall portion 28, that is, the end portion on one side (+D1 side) in the first direction D1 is positioned lower than the upper end of the through hole 25a, that is, on the other side (−D1 side) in the first direction D1.

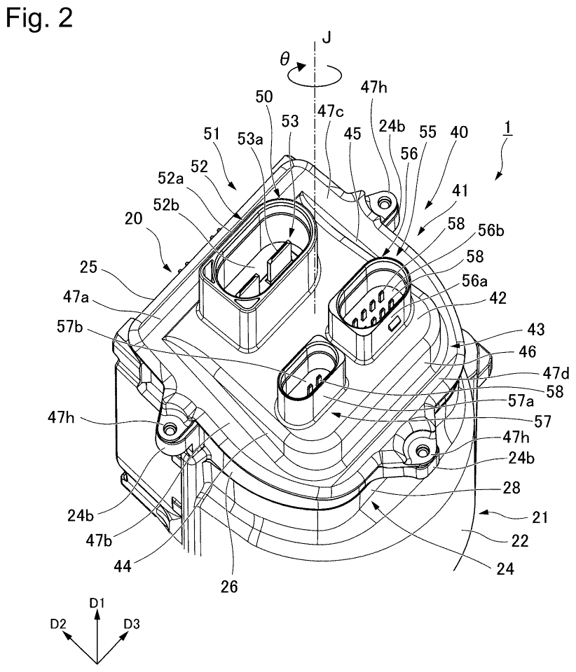

As illustrated in FIG. 2, the first protrusion portion 24b protrudes radially outward from the peripheral wall portion 24. The peripheral wall portion 24 is provided with three first protrusion portions 24b. The first protrusion portions 24b are each disposed at intervals along the circumferential direction. Although not illustrated, the first protrusion portions 24b are each provided with a female screw hole penetrating in the first direction D1.

As illustrated in FIG. 1, the lid portion 40 is fixed to the upper end of the housing 21, that is, the end portion on one side (+D1 side) in the first direction D1. The lid portion 40 closes the opening portion 24a. As illustrated in FIG. 2, the shape of the lid portion 40 viewed from the first direction D1 is similar to the shape of the housing 21 viewed from the first direction D1. The lid portion 40 includes a cover 41 and a connector 50.

As illustrated in FIG. 1, the cover 41 closes the opening portion 24a. The cover 41 is a part other than the connector 50 of the lid portion 40. The cover 41 includes a top wall portion 42, a side wall portion 43, an attachment portion 47, and a second board fixing portion 48.

The top wall portion 42 has a plate shape extending in a direction orthogonal to the first direction D1. As illustrated in FIG. 2, the top wall portion 42 has a substantially rectangular shape as viewed in the first direction D1. The side wall portion 43 has a plate shape protruding downward from an edge portion of the top wall portion 42. The side wall portion 43 includes a first side wall portion 44, a second side wall portion 45, and a third side wall portion 46.

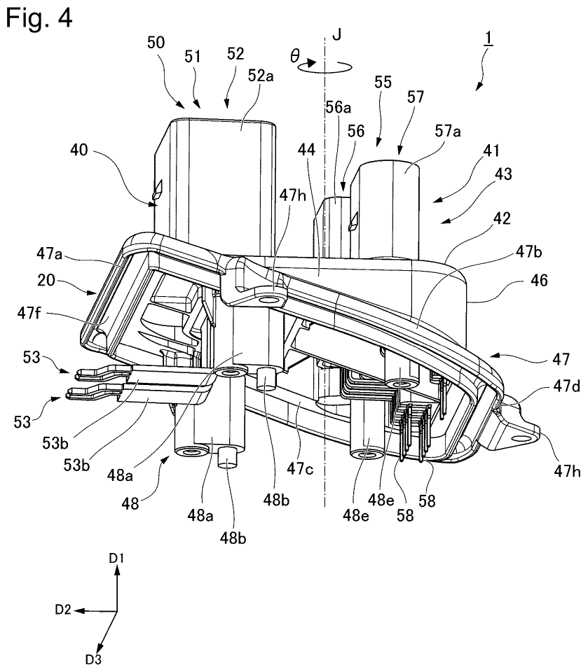

As illustrated in FIG. 4, the first side wall portion 44 has a plate shape protruding downward from the edge portion on the other side (−D3 side) in the third direction D3 of the top wall portion 42. The plate surface of the first side wall portion 44 faces the third direction D3. As viewed in the third direction D3, the upper end of the first side wall portion 44 extends in the second direction D2. The lower end of the first side wall portion 44 is linearly inclined so as to be positioned downward from one side (+D2 side) in the second direction D2 toward the other side (−D2 side) in the second direction D2. Although not illustrated, as viewed in the third direction D3, the direction in which the lower end of the first side wall portion 44 extends is parallel to the direction in which the upper end of the second peripheral wall portion 26 of the housing 21 extends. As viewed in the third direction D3, the first side wall portion 44 has a substantially right triangular shape with a lower end as an oblique side.

As illustrated in FIG. 2, the second side wall portion 45 has a plate shape protruding downward from the edge portion on one side (+D3 side) in the third direction D3 of the top wall portion 42. As viewed in the third direction D3, the second side wall portion 45 overlaps the first side wall portion 44. As viewed in the third direction D3, the shape of the second side wall portion 45 is identical to the shape of the first side wall portion 44. Although not illustrated, as viewed in the third direction D3, the direction in which the lower end of the second side wall portion 45 extends is parallel to the direction in which the upper end of the third peripheral wall portion 27 of the housing 21 extends.

As illustrated in FIG. 1, the third side wall portion 46 has a plate shape protruding downward from the edge portion on the other side (−D2 side) in the second direction D2 of the top wall portion 42. The plate surface of the third side wall portion 46 faces the second direction D2. As illustrated in FIG. 2, as viewed in the second direction D2, the third side wall portion 46 has a substantially rectangular shape whose long side extends in the third direction D3. The end portion on the other side (−D3 side) in the third direction D3 of the third side wall portion 46 is connected to the end portion on the other side in the second direction D2 of the first side wall portion 44. The end portion on one side (+D3 side) in the third direction D3 of the third side wall portion 46 is connected to the end portion on the other side in the second direction D2 of the second side wall portion 45. In the second direction D2, the third side wall portion 46 faces a part of the first peripheral wall portion 25. As viewed in the second direction, the third side wall portion 46 overlaps the through hole 25a.

As viewed in the first direction D1, the attachment portion 47 has a plate shape surrounding the top wall portion 42 and the side wall portion 43 from radially outside. As viewed in the first direction D1, the radially outer edge of the attachment portion 47 is the radially outer edge of the cover 41. The attachment portion 47 includes a first attachment portion 47a, a second attachment portion 47b, a third attachment portion 47c, a fourth attachment portion 47d, and a second protrusion portion 47h. As illustrated in FIG. 4, the attachment portion 47 has a loop groove portion 47f.

As illustrated in FIG. 2, the first attachment portion 47a has a plate shape extending in the third direction D3. The first attachment portion 47a is disposed on one side (+D2 side) in the second direction D2 relative to the top wall portion 42. The first attachment portion 47a is connected to the edge portion on one side in the second direction D2 of the top wall portion 42.

The second attachment portion 47b has a plate shape positioned downward from one side (+D2 side) in the second direction D2 toward the other side (−D2 side) in the second direction D2. The second attachment portion 47b extends in a direction substantially parallel to the direction in which the lower end of the first side wall portion 44 extends. The second attachment portion 47b is disposed on the other side (−D3 side) in the third direction D3 relative to the first side wall portion 44. The second attachment portion 47b is connected to the lower end of the first side wall portion 44. The second attachment portion 47b is connected to a part on the other side in the third direction D3 of the first attachment portion 47a.

The third attachment portion 47c has a plate shape positioned downward from one side (+D2 side) in the second direction D2 toward the other side (−D2 side) in the second direction D2. Although not illustrated, the third attachment portion 47c extends in a direction parallel to the direction in which the lower end of the second side wall portion 45 extends. The third attachment portion 47c is disposed on one side (+D3 side) in the third direction D3 relative to the second side wall portion 45. The third attachment portion 47c is connected to the lower end of the second side wall portion 45. The third attachment portion 47c is connected to a part on one side in the third direction D3 of the first attachment portion 47a.

The fourth attachment portion 47d has a plate shape extending in the third direction D3. The fourth attachment portion 47d is disposed on the other side (−D2 side) in the second direction D2 relative to the third side wall portion 46. The fourth attachment portion 47d is connected to the lower end of the third side wall portion 46. The fourth attachment portion 47d is connected to the second attachment portion 47b and the third attachment portion 47c.

As illustrated in FIG. 4, the loop groove portion 47f is a groove recessed upward from the surface facing downward of the attachment portion 47. The loop groove portion 47f has a loop surrounding the central axis J. As illustrated in FIG. 1, the upper end of the peripheral wall portion 24 is inserted inside the loop groove portion 47f over the entire circumference in the circumferential direction. As illustrated in FIG. 4, a part on one side (+D2 side) in the second direction D2 of the loop groove portion 47f extends linearly in the third direction D3, and the upper end of the first peripheral wall portion 25 is inserted therein as illustrated in FIG. 1. As illustrated in FIG. 4, each of the part on the other side (−D3 side) in the third direction D3 and the part on one side (+D3 side) in the third direction D3 of the loop groove portion 47f is linearly inclined so as to be positioned downward from one side in the second direction D2 toward the other side (−D side) in the second direction D2, and although not illustrated, each of the upper end of the second peripheral wall portion 26 and the upper end of the third peripheral wall portion 27 is inserted. A part on the other side in the second direction D2 of the loop groove portion 47f extends linearly in the third direction D3, and the upper end of the fourth peripheral wall portion 28 is inserted therein as illustrated in FIG. 1.

A sealing material 94 is disposed between the inner surface of the loop groove portion 47f and the upper end of the peripheral wall portion 24. That is, the sealing material 94 is disposed between the cover 41 and the upper end of the housing 21, that is, the end portion on one side (+D1 side) in the first direction D1. The sealing material 94 comes into contact with both the inner surface of the loop groove portion 47f and the peripheral wall portion 24. The sealing material 94 seals between the cover 41 and the housing 21. Although not illustrated, the sealing material 94 is disposed over the entire circumference in the circumferential direction inside the loop groove portion 47f. This seals between the cover 41 and the housing 21 over the entire circumference in the circumferential direction. In the present example embodiment, as the sealing material 94, for example, a liquid gasket having elasticity such as a silicone-based gasket and an acrylic gasket can be used. In a process of attaching the lid portion 40 to the housing 21, the liquid sealing material 94 is applied to the inside of the loop groove portion 47f, and the liquid sealing material 94 is cured after the lid portion 40 is attached to the housing 21, whereby the sealing material 94 is configured. The sealing material 94 may be an O-ring having a loop.

As illustrated in FIG. 2, the second protrusion portion 47h protrudes radially outward from the attachment portion 47. The attachment portion 47 is provided with three second protrusion portions 47h. The second protrusion portions 47h are each disposed at intervals along the circumferential direction. Each of the second protrusion portions 47h overlaps the first protrusion portion 24b in the first direction D1. Each of the second protrusion portions 47h comes: into contact with the first protrusion portion 24b in the first direction D1. Each of the second protrusion portions 47h is provided with a hole penetrating in the first direction D1. When a bolt not illustrated is passed through the hole of each of the second protrusion portions 47h in the first direction D1 and is tightened into the female screw hole of the first protrusion portion 24b, the cover 41 is fixed to the housing 21. Due to this, the lid portion 40 is fixed to the housing 21. As illustrated in FIG. 1, the lower end of the second protrusion portion 47h is the lower end of the cover 41. The lower end of the second protrusion portion 47h is positioned upper than the lower end of the through hole 25a. That is, the lower end of the through hole 25a is positioned lower than the lower end of the cover 41.

As illustrated in FIG. 4, the second board fixing portion 48 has a columnar shape protruding in the first direction D1. In the present example embodiment, the second board fixing portion 48 includes two first fixing portions 48a and two second fixing portions 48e.

Each of the two first fixing portions 48a protrudes downward from a part on one side (+D2 side) in the second direction D2 of the attachment portion 47. The two first fixing portions 48a are disposed at intervals in the third direction D3. One of the first fixing portions 48a is connected to the second attachment portion 47b. The other of the first fixing portions 48a is connected to the third attachment portion 47c. A surface facing the lower side of each of the first fixing portions 48a is provided with a female screw hole recessed upward. Each of the first fixing portions 48a is provided with an insertion portion 48b. The insertion portion 48b has a cylindrical shape protruding downward from a surface facing downward of the first fixing portion 48a.

Each of the two second fixing portions 48e protrudes downward from a part on the other side (−D2 side) in the second direction D2 of the top wall portion 42. The two second fixing portions 48e are disposed on the other side in the second direction D2 relative to the first fixing portion 48a. The two second fixing portions 48e are disposed at intervals in the third direction D3. A surface facing the lower side of each of the second fixing portions 48e is provided with a female screw hole recessed upward. As illustrated in FIG. 1, in the first direction D1, the lower end of the second fixing portion 48e is substantially at the same position as the lower end of the first fixing portion 48a.

The connector 50 electrically connects the control unit 70 and an external connector not illustrated. The external connector is electrically connected to each unit such as a power supply unit and a main control unit included in the vehicle. Due to these, the control unit 70 is electrically connected to each unit such as the power supply unit and the main control unit included in the vehicle. The external connector can be inserted into and removed from the connector 50. As illustrated in FIG. 1, the connector 50 is disposed upper than the housing 21, that is, one side (+D1 side) in the first direction. As illustrated in FIG. 2, the connector 50 includes a first connector 51 and a second connector 55. The first connector 51 is connected to a part on one side (+D2 side) in the second direction D2 of the top wall portion 42. The second connector 55 is connected to a part on the other side (−D2 side) in the second direction D2 of the top wall portion 42. Thus, the connector 50 is connected to the cover 41. The second connector 55 is disposed on the other side in the second direction D2 relative to the first connector 51.

As illustrated in FIG. 1, the first connector 51 includes a holder 52 and a first terminal 53. The holder 52 has an insulating property. In the present example embodiment, the holder 52 is made of resin. The holder 52 holds the first terminal 53. The holder 52 includes a first tubular portion 52a and a first bottom wall portion 52b.

The first tubular portion 52a protrudes upward from the top wall portion 42. As illustrated in FIG. 2, the first tubular portion 52a has a substantially quadrangular tubular shape that is opening upward and long in the third direction D3. The first tubular portion 52a is connected to the top wall portion 42. As illustrated in FIG. 1, the first bottom wall portion 52b has a plate shape extending in a direction orthogonal to the first direction D1. The outer edge of the first bottom wall portion 52b is connected to the lower end of the first tubular portion 52a. The first bottom wall portion 52b holds the first terminal 53.

The first terminal 53 is an elongated member made of metal. In the present example embodiment, a part of the first terminal 53 is embedded in the first bottom wall portion 52b. Due to this, the first terminal 53 is held by the holder 52. As illustrated in FIG. 2, in the present example embodiment, the first connector 51 includes two first terminals 53. The first terminals 53 are disposed at intervals in the third direction D3. As illustrated in FIG. 1, the first terminal 53 includes a first extending portion 53a and a second extending portion 53b. The first extending portion 53a extends in the first direction D1. The first extending portion 53a passes through the first bottom wall portion 52b in the first direction D1. The first extending portion 53a is held by the holder 52. The upper end of the first extending portion 53a is positioned inside the first tubular portion 52a. Since the first extending portion 53a is exposed in the first tubular portion 52a, the first terminal 53 is exposed to the outside of the case 20. The lower end of the first extending portion 53a is positioned inside the case 20.

The second extending portion 53b extends from the lower end of the first extending portion 53a to one side (+D2 side) in the second direction D2. The second extending portion 53b passes through the through hole 25a in the second direction D2. The end portion on one side in the second direction D2 of the second extending portion 53b is positioned inside the board cover member 60. The second extending portion 53b is positioned upper than the upper end of the fourth peripheral wall portion 28. That is, the upper end of the housing 21, that is, the upper end of the fourth peripheral wall portion 28 that is a part facing the through hole 25a in the second direction D2 of the end portion on one side (+D1 side) in the first direction D1 is positioned lower than the first terminal 53, that is, on the other side (−D1 side) in the first direction D1.

As illustrated in FIG. 2, the second connector 55 includes a second holder 56, a third holder 57, and a second terminal 58. The second holder 56 and the third holder 57 have an insulating property. In the present example embodiment, the second holder 56 and the third holder 57 are made of resin. Each of the second holder 56 and the third holder 57 holds the second terminal 58. The second holder 56 and the third holder 57 are disposed at intervals in the third direction D3. The second holder 56 is disposed on one side (+D3 side) in the third direction D3 relative to the third holder 57. The second holder 56 includes a second tubular portion 56a and a second bottom wall portion 56b. The third holder 57 includes a third tubular portion 57a and a third bottom wall portion 57b.

The second tubular portion 56a protrudes upward from the top wall portion 42. The second tubular portion 56a has a substantially quadrangular tubular shape that is opening upward and long in the third direction D3. The second tubular portion 56a is connected to the top wall portion 42. As illustrated in FIG. 1, the second bottom wall portion 56b has a plate shape extending in a direction orthogonal to the first direction D1. The outer edge of the second bottom wall portion 56b is connected to the lower end of the second tubular portion 56a. The second bottom wall portion 56b holds the second terminal 58.

As illustrated in FIG. 2, the third tubular portion 57a protrudes upward from the top wall portion 42. The third tubular portion 57a has a substantially quadrangular tubular shape that is opening upward and long in the third direction D3. The third tubular portion 57a is connected to the top wall portion 42. The third bottom wall portion 57b has a plate shape extending in a direction orthogonal to the first direction D1. The outer edge of the third bottom wall portion 57b is connected to the lower end of the third tubular portion 57a. The third bottom wall portion 57b holds the second terminal 58.

The second terminal 58 is an elongated member made of metal. In the present example embodiment, the connector 50 includes a plurality of the second terminals 58. Some of the second terminals 58 are embedded in the second bottom wall portion 56b and held by the second holder 56. The other of the second terminals 58 are embedded in the third bottom wall portion 57b and held by the third holder 57. The upper end of the second terminal 58 is positioned inside the second tubular portion 56a and the third tubular portion 57a and exposed to the outside of the case 20. As illustrated in FIG. 1, the lower end of the second terminal 58 is positioned inside the case 20.

In the present example embodiment, each of the cover 41, the holder 52, the second holder 56, and the third holder is a part of a single member identical to one another. That is, the cover 41 is formed using the identical member to the holder 52. In the present example embodiment, the lid portion 40 is formed by insert molding using the first terminal 53 and the second terminal 58 as insert members.

As illustrated in FIG. 1, the board cover member 60 is fixed to the outer surface of the housing 21 by a bolt not illustrated. More specifically, the board cover member 60 is fixed to an outer surface facing one side (+D2 side) in the second direction D2 of the first peripheral wall portion 25. The board cover member 60 has a plate shape extending in a direction orthogonal to the second direction D2. The board cover member 60 is disposed on one side in the second direction D2 relative to the through hole 25a.

The control unit 70 controls the operation of the motor unit 10. The control unit 70 is accommodated inside the case 20. The control unit 70 includes a first board 71, a second board 72, and an inter-board connector 75. The first board 71 and the second board 72 are electrically connected via the inter-board connector 75. The first board 71 and the second board 72 are electrically connected to the motor unit 10 via a bus bar not illustrated or the like.

The first board 71 is disposed between the housing 21 and the board cover member 60. The first board 71 is disposed on one side (+D2 side) in the second direction D2 with respect to the housing 21. The first board 71 has a plate shape extending in a direction orthogonal to the second direction D2. The first board 71 is mounted with a plurality of electronic elements constituting an inverter circuit not illustrated or the like. The inverter circuit provided on the first board 71 supplies the stator 12 with power. The first board 71 is fixed to the housing 21. The first board 71 is fixed to the housing 21 by a screw not illustrated. More specifically, the first board 71 is fixed to the outer surface facing one side in the second direction D2 of the first peripheral wall portion 25. As viewed in the second direction D2, a part of the first board 71 overlaps the through hole 25a. The second extending portion 53b of the first terminal 53 is connected to the first board 71. The second extending portion 53b is connected to the first board 71 by soldering, for example. Due to this, the first board 71 and the first connector 51 are electrically connected. The first board 71 and the external connector not illustrated are electrically connected via the first connector 51.

The second board 72 is accommodated in a space formed by the peripheral wall portion 24 and the lid portion 40. The second board 72 is disposed on a lower side relative to the connector 50, that is, the other side (−D1 side) in the first direction D1. As viewed in the first direction D1, the second board 72 overlaps the connector 50. The second board 72 is disposed upper than the motor unit 10. As viewed in the first direction D1, the second board 72 overlaps the motor unit 10. In the first direction D1, the lower end of the cover 41, that is, the lower end of the second protrusion portion 47h is positioned lower than the second board 72. The second board 72 has a plate shape extending in a direction orthogonal to the first direction D1. The plurality of second terminals 58 are connected to the second board 72. The plurality of second terminals 58 are connected to the second board 72 by soldering, for example. Due to this, the control unit 70 and the second connector 55 are electrically connected. The second board 72 and the external connector not illustrated are electrically connected via the second connector 55. The second board 72 is provided with a first hole portion 72a and a second hole portion 72b.

Each of the first hole portion 72a and the second hole portion 72b is a hole penetrating the second board 72 in the first direction D1. In the present example embodiment, the second board 72 is provided with four first hole portions 72a and two second hole portions 72b. Although not illustrated, as viewed in the first direction D1, two of the first hole portions 72a overlap the female screw hole of the first fixing portion 48a. Although not illustrated, as viewed in the first direction D1, the other two first hole portions 72a overlap the female screw hole of the second fixing portion 48e. When a screw 93 is passed through each of the first hole portions 72a and tightened into the female screw hole of each of the first fixing portion 48a and the second fixing portion 48e, the second board 72 is fixed to the lid portion 40. That is, the second board 72 is fixed only to the lid portion 40 of the lid portion 40 and the housing 21. The insertion portion 48b passes through each of the two second hole portions 72b in the first direction D1. Due to this, the circumferential and radial positions of the second board 72 with respect to the lid portion 40 are determined.

According to the present example embodiment, the rotary electric machine 1 includes the second board 72 disposed lower than the connector 50, that is, on the other side (−D1 side) in the first direction D1, the connector 50 includes the second terminal 58 connected to the second board 72, and the second board 72 is fixed only to the lid portion 40 of the lid portion 40 and the housing 21. When the external connector is inserted into and removed from the connector 50, if the lid portion 40 is elastically deformed in the first direction D1 due to a frictional force or the like between the connector 50 and the external connector, a force facing the first direction D1 is applied to the second board 72 via the second terminal 58. Unlike the configuration of the present example embodiment, in a case of a configuration in which the second board 72 is fixed to the housing 21, stress is applied to a connection portion, for example, solder that connects the second terminal 58 and the second board 72, and thus there is a possibility that the connection between the second terminal 58 and the second board 72 becomes unstable. On the other hand, in the present example embodiment, since the second board 72 is fixed only to the lid portion 40 as described above, even if the lid portion 40 is deformed in the first direction D1 when the external connector is inserted into and removed from the connector 50, the second board 72 moves in the first direction D1 in accordance with the deformation of the lid portion 40. This can significantly reduce the stress applied to the connection portion connecting the second terminal 58 and the second board 72 as compared with the configuration in which the second board 72 is fixed to the housing 21. Therefore, since the connection between the second terminal 58 and the second board 72 is stabilized, the rotary electric machine 1 can be operated stably.

The inter-board connector 75 is connected to each of the first board 71 and the second board 72. The inter-board connector 75 is disposed on a lower side relative to the second board 72 and on the other side (−D2 side) in the second direction D2 relative to the first board 71. The inter-board connector 75 passes through the through hole 25a in the second direction D2. The inter-board connector 75 includes a plurality of connector pins. One end of each connector pin is connected to the first board 71, and the other end of each connector pin is connected to the second board 72. The connector pins are connected to each of the first board 71 and the second board 72 by soldering, for example.

Next, a manufacturing method of the rotary electric machine 1 of the present example embodiment will be described. The manufacturing process of the rotary electric machine 1 of the present example embodiment includes a lid portion fixing process Mc of fixing the lid portion 40 to the housing 21. The lid portion fixing process Mc includes a first process S1 and a second process S2. In the present description, a “worker or the like” includes a worker who performs each work of the lid portion fixing process Mc, and an assembly device. Each work may be performed only by the worker, may be performed only by the assembly device, or may be performed by the worker and the assembly device.

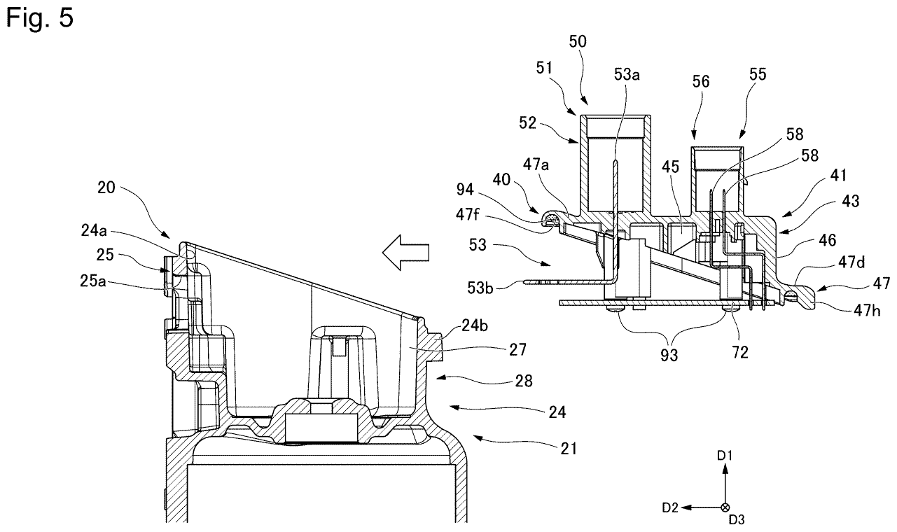

The first process S1 is a process of moving the lid portion 40, that is, the connector 50 and the cover 41 from the other side (−D2 side) in the second direction D2 to one side (+D2 side) in the second direction D2 of the housing 21 and passing the second extending portion 53b of the first terminal 53 through the through hole 25a. In the first process S1, as illustrated in FIG. 5, the worker or the like disposes the lid portion 40 on the other side in the second direction D2 of the housing 21 fixed to a jig or the like not illustrated. The second board 72 is fixed to the lid portion 40 in advance. In the lid portion fixing process Mc, before the first process S1, an application process Sa of applying the liquid sealing material 94 over the entire circumference in the circumferential direction to the inside of the loop groove portion 47f of the lid portion 40 is performed. At this time, the worker or the like disposes the second board 72 upper than the upper end of the fourth peripheral wall portion 28 and disposes the second extending portion 53b of the first terminal 53 lower than the upper end of the through hole 25a in the first direction D1. As described above, in the present example embodiment, the upper end of the fourth peripheral wall portion 28 facing the through hole 25a in the second direction D2 among the upper ends of the housing 21 is positioned lower than the upper end of the through hole 25a, and thus the lid portion 40 can be disposed with respect to the housing 21 as described above. In the present example embodiment, the O-ring having a loop as the sealing material 94 may be disposed over the entire circumference in the circumferential direction inside the loop groove portion 47f.

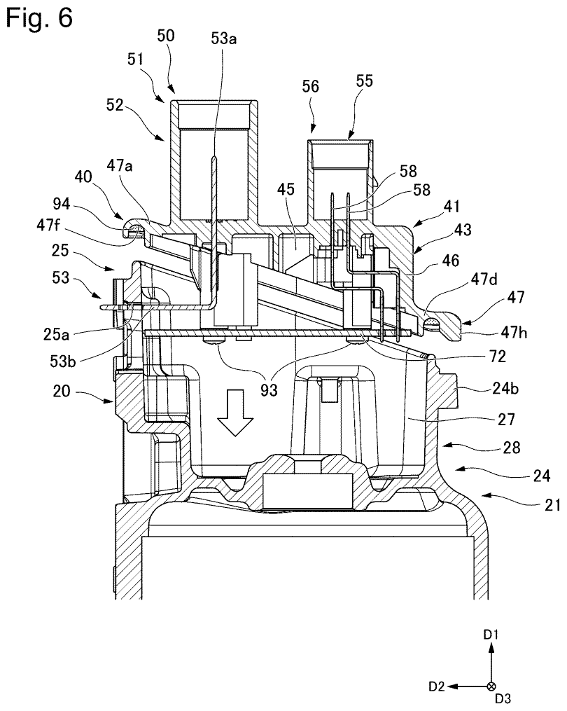

Next, the worker or the like moves the lid portion 40 to one side (+D2 side) in the second direction D2. As described above, since the second board 72 is disposed upper than the fourth peripheral wall portion 28, as illustrated in FIG. 6, each of the lid portion 40 and the second board 72 can pass through on the upper side of the fourth peripheral wall portion 28 toward one side in the second direction D2. That is, each of the lid portion 40 and the second board 72 can move toward one side in the second direction D2 inside the peripheral wall portion 24 without interfering with the fourth peripheral wall portion 28. As described above, since the second extending portion 53b is disposed lower than the upper end of the through hole 25a, when the lid portion 40 is further moved to one side in the second direction D2, the second extending portion 53b is passed through the through hole 25a in the second direction D2. Upon moving the lid portion 40 to one side in the second direction D2 until the loop groove portion 47f is positioned on the upper side of the peripheral wall portion 24, the worker or the like stops movement of the lid portion 40.

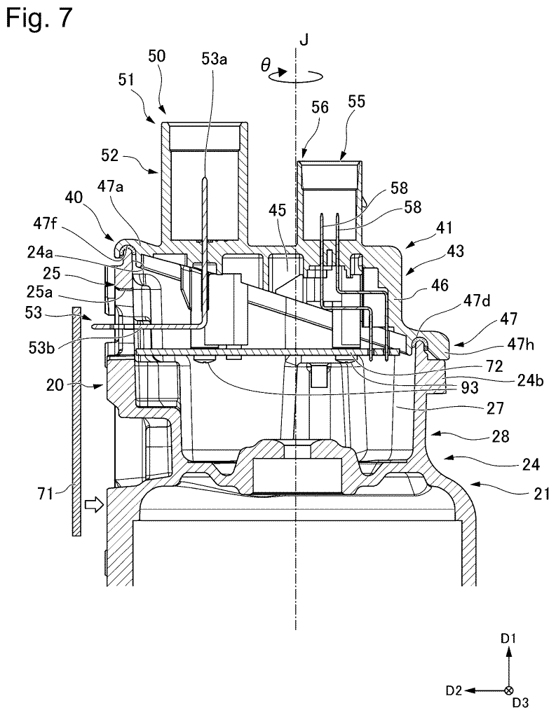

Next, the worker or the like moves the lid portion 40 downward, and brings the second protrusion portion 47h into contact with the first protrusion portion 24b while inserting the upper end of the peripheral wall portion 24 into the loop groove portion 47f as illustrated in FIG. 7. At this time, the sealing material 94 comes into contact with the peripheral wall portion 24. Due to this, the sealing material 94 comes into contact with both the cover 41 and the peripheral wall portion 24 over the entire circumference in the circumferential direction. Next, when the worker or the like fixes the second protrusion portion 47h to the first protrusion portion 24b with a bolt not illustrated, the lid portion 40 is fixed to the housing 21. The sealing material 94 sealing the housing 21 and the lid portion 40 is cured with the lapse of time. This seals between the cover 41 and the housing 21 over the entire circumference in the circumferential direction. When curing of the sealing material 94 ends, the first process S1 ends.

According to the present example embodiment, the upper end, that is, the end portion on one side (+D1 side) in the first direction D1 of the housing 21 is positioned downward, that is, the other side (−D1 side) in the first direction D1 from one side (+D2 side) in the second direction D2 toward the other side (−D2 side) in the second direction D2. Between the cover 41 and the upper end of the housing 21, the sealing material 94 sealing between the cover 41 and the housing 21 is disposed. Therefore, as viewed in the third direction D3, the shape of the upper end of the housing 21 is easily formed into a shape having no corner portion or a shape having a large angle of the corner portion even if the housing has the corner portion. Therefore, the liquid sealing material 94 is easily applied uniformly when the sealing material 94 is applied to the loop groove portion 47f of the lid portion 40 in the application process Sa. Therefore, in the first process S1, air is easily suppressed from being caught in the liquid sealing material 94. Therefore, generation of a cavity in the cured sealing material 94 is easily suppressed, and thus the sealing performance between the cover 41 and the housing 21 can be improved. When the liquid sealing material 94 is applied to the loop groove portion 47f of the lid portion 40, the sealing material 94 is easily applied uniformly, and thus the application process Sa is easily simplified.

In the present example embodiment, when the O-ring having a loop is used as the sealing material 94, since as described above, the shape of the upper end of the housing 21 is easily formed into a shape having no corner portion or a shape having a large angle of the corner portion even if the housing has the corner portion, the O-ring and the upper end of the housing 21 are easily stably brought into contact with each other. Therefore, generation of a gap between the O-ring and the upper end of the housing 21 is easily suppressed, and thus the sealing performance between the cover 41 and the housing 21 can be improved.

In the present example embodiment, as described above, in the first direction D1, the upper end of the fourth peripheral wall portion 28 is positioned lower than the upper end of the first peripheral wall portion 25. As viewed in the third direction D3, the upper ends of the second peripheral wall portion 26 and the third peripheral wall portion 27 are positioned downward from one side (+D2 side) in the second direction D2 toward the other side (−D2 side) in the second direction D2. Therefore, the volume of the housing 21 can be easily reduced as compared with the housing having a configuration in which the upper ends of the second peripheral wall portion 26, the third peripheral wall portion 27, and the fourth peripheral wall portion 28 are positioned at the same position as the upper end of the first peripheral wall portion 25 in the first direction D1. In the present example embodiment, the upper side of the peripheral wall portion 24 is covered with the first side wall portion 44, the second side wall portion 45, and the third side wall portion 46 included in the cover 41. Therefore, in the present example embodiment, the volume of the metal housing 21 can be easily reduced, and the volume of the resin cover 41 can be easily increased. Therefore, the weight of the case 20 can be reduced, and the manufacturing cost of the case 20 can be reduced.

According to the present example embodiment, as viewed in the third direction D3, the upper end of the housing 21, that is, the end portion on one side (+D1 side) in the first direction D1 is linearly inclined. Hence, the liquid sealing material 94 is easily applied uniformly when the sealing material 94 is applied to the loop groove portion 47f of the lid portion 40 in the application process Sa. Therefore, in the first process S1, air is easily suppressed more suitably from being caught in the liquid sealing material 94. Therefore, generation of a cavity in the cured sealing material 94 is easily suppressed more suitably, and thus the sealing performance between the cover 41 and the housing 21 can be further improved. When the liquid sealing material 94 is applied to the loop groove portion 47f of the lid portion 40, the sealing material 94 is easily applied uniformly, and thus the application process is easily simplified.

In the present example embodiment, when the liquid sealing material 94 is applied to the inside of the loop groove portion 47f with a jig or the like, the liquid sealing material 94 can be applied over the entire circumference in the circumferential direction inside the loop groove portion 47f by moving a nozzle included in the jig or the like only linearly. Therefore, the configuration of the jig and the like can be simplified, and the control program for operating the jig and the like can be simplified.

In the present example embodiment, when the O-ring having a loop is used as the sealing material 94, since as described above, the shape of the upper end of the housing 21 is inclined linearly, the O-ring and the upper end of the housing 21 are more easily stably brought into contact with each other. Therefore, generation of a gap between the O-ring and the upper end of the housing 21 is more easily suppressed, and thus the sealing performance between the cover 41 and the housing 21 can be further improved.

The second process S2 is a process of connecting the second extending portion 53b of the first terminal 53 to the first board 71. As illustrated in FIG. 7, the worker or the like disposes the first board 71 on one side (+D2 side) in the second direction D2 of the housing 21, and moves the first board 71 to the other side (−D2 side) in the second direction D2. Next, the worker or the like passes the second extending portion 53b through a hole portion not illustrated of the first board 71 in the second direction D2. Next, the worker or the like fixes the first board 71 onto a surface facing one side in the second direction D2 of the first peripheral wall portion 25 with a screw or the like not illustrated. Next, the worker or the like connects the second extending portion 53b to the first board 71 by soldering, for example. Due to this, the first connector 51 is electrically connected to the first board 71. When the second extending portion 53b is connected to the first board 71, the second process S2 ends. When the second process S2 ends, as illustrated in FIG. 1, the first board 71 is fixed to the housing 21, and the second extending portion 53b is connected to the first board 71. In the second process S2, the worker or the like also performs a work of connecting, to the first board 71, the plurality of connector pins of the inter-board connector 75 connected to the second board 72 in advance.

The work of fixing the first board 71 to the housing 21 may be performed in a process before the first process S1. In this case, in the above-described first process S1, when moving the lid portion 40 to one side (+D2 side) in the second direction D2, the worker or the like passes the second extending portion 53b through the hole portion not illustrated of the first board 71. In this case, in the second process S2, the worker or the like performs only the work of connecting the second extending portion 53b to the first board 71 by soldering, for example.

According to the present example embodiment, the rotary electric machine 1 includes the housing 21, the first board 71 disposed on one side (+D2 side) in the second direction D2 with respect to the housing 21, and the lid portion 40 fixed to the upper end of the housing 21, that is, the end portion on one side (+D1 side) in the first direction D1. The housing 21 include the through hole 25a penetrating the housing 21 in the second direction D2, and the lid portion 40 includes the connector 50 having the first terminal 53 and the holder 52 holding the first terminal 53, and the cover 41 covering the opening portion 24a and formed using the same structure as the holder 52. The first terminal 53 includes the second extending portion 53b extending in the second direction D2, passed through the through hole 25a in the second direction D2, and connected to the first board 71. The upper end of the fourth peripheral wall portion 28, which is a part facing the through hole 25a in the second direction D2 among the upper ends of the housing 21, is positioned lower than the upper end of the through hole 25a, that is, on the other side (−D1 side) in the first direction D1. Therefore, since the upper end of the fourth peripheral wall portion 28 of the housing 21 is positioned lower than the upper end of the through hole 25a, as described above, in the first process S1 of the lid portion fixing process Mc, the simple work of moving the lid portion 40 to one side in the second direction D2 with respect to the housing 21 enables the second extending portion 53b of the first terminal 53 to pass through the through hole 25a while suppressing the cover 41 and the first terminal 53 from interfering with the housing 21. Therefore, even in a configuration in which the connector 50 and the cover 41 are a single member, the lid portion 40 including the connector 50 and the cover 41 can be easily attached to the housing 21. As described above, since the connector 50 and the cover 41 are a single member, a work of attaching the connector 50 to the cover 41 becomes unnecessary as compared with a configuration in which the connector 50 and the cover 41 are separately provided. Therefore, since the number of man-hours in the first process S1 of the lid portion fixing process Mc can be reduced, the number of man-hours for manufacturing the rotary electric machine 1 can be reduced. That is, according to the present example embodiment, the assembly process of the rotary electric machine 1 can be simplified.

In the present example embodiment, as described above, since the connector 50 and the cover 41 are a single member, the number of components of the rotary electric machine 1 can be reduced as compared with a configuration in which the connector 50 and the cover 41 are separately provided. Therefore, an increase in the manufacturing cost of the rotary electric machine 1 can be suppressed.

According to the present example embodiment, the upper end of the housing 21, that is, the upper end of the fourth peripheral wall portion 28 that is a part facing the through hole 25a in the second direction D2 of the end portion on one side (+D1 side) in the first direction D1 is positioned lower than the first terminal 53, that is, on the other side (−D1 side) in the first direction D1. Therefore, in the first process S1 of the lid portion fixing process Mc, the first terminal 53 can be more suitably suppressed from interfering with the housing 21 when the lid portion 40 is moved to one side (+D2 side) in the second direction D2. Therefore, the lid portion 40 can be more easily attached to the housing 21. Therefore, since the number of man-hours in the first process S1 of the lid portion fixing process Mc can be further reduced, the number of man-hours for manufacturing the rotary electric machine 1 can be further reduced. That is, according to the present example embodiment, the assembly process of the rotary electric machine 1 can be simplified.

According to the present example embodiment, the manufacturing method of the rotary electric machine 1 includes the first process S1 of moving the connector 50 and the cover 41 from the other side (−D2 side) in the second direction D2 to one side (+D2 side) in the second direction D2 of the housing 21 and passing the second extending portion 53b through the through hole 25a, and the second process S2 of connecting the second extending portion 53b to the first board 71. Therefore, as described above, in the first process S1 of the lid portion fixing process Mc, the simple work of moving the lid portion 40 to one side in the second direction D2 with respect to the housing 21 enables the second extending portion 53b of the first terminal 53 to pass through the through hole 25a while suppressing the lid portion 40 from interfering with the housing 21. Therefore, even in a configuration in which the connector 50 and the cover 41 are a single member, the lid portion 40 can be easily attached to the housing 21. As described above, since the connector 50 and the cover 41 are a single member, a work of attaching the connector 50 to the cover 41 becomes unnecessary. Therefore, since the number of man-hours in the first process S1 of the lid portion fixing process Mc can be reduced, the number of man-hours for manufacturing the rotary electric machine 1 can be reduced. That is, according to the present example embodiment, the assembly process of the rotary electric machine 1 can be simplified.

Although the example embodiment of the present disclosure is described above, the configurations in the example embodiment and combinations thereof are merely examples, and addition, omission, substitution, and other changes of the configuration can be made within a range not departing from the gist of the present disclosure. The present disclosure is not limited by the example embodiment.

The shape of the peripheral wall portion is not particularly limited as long as the upper end of the fourth peripheral wall portion is positioned lower than the upper end of the through hole in the first direction. For example, the upper end of the second peripheral wall portion and the upper end of the third peripheral wall portion as viewed in the third direction may have curved shapes such as an arc shape protruding upward and an arc shape protruding downward, or may have corner portions. The upper end of the second peripheral wall portion and the upper end of the third peripheral wall portion may each extend linearly in the second direction. In this case, as viewed in the third direction, each of the second peripheral wall portion and the third peripheral wall portion has a rectangular shape, and the peripheral wall portion opens to the other side in the second direction.

The material constituting the sealing material is not particularly limited, and may be an elastomer such as rubber, or may be an elastic adhesive such as a silicone-based adhesive and a modified silicone-based adhesive. The sealing material may be an elastic body such as a rubber sheet.

The application of the rotary electric machine to which the present disclosure is applied is not particularly limited. The rotary electric machine may be mounted on any device. The rotary electric machine needs not be mounted in a vehicle. The electronic device to which the present disclosure is applied may be a device other than rotary electric machine. The configurations described in the present description can be appropriately combined within a range not contradictory to one another.

Note that the present techniques can have the following configurations.
(1) A rotary electric machine including a housing having a tubular shape extending in a first direction and including an opening that opens to one side in the first direction, a first board disposed on one side in a second direction intersecting the first direction with respect to the housing, and a lid fixed to an end portion on one side in the first direction of the housing, in which the housing includes a through hole penetrating the housing in the second direction, the lid includes a connector including a first terminal and a holder to hold the first terminal, and a cover that covers the opening and defined by a same structure as that of the holder, the first terminal includes a first extending portion extending in the first direction and held by the holder, and a second extending portion extending in the second direction, passing through the through hole in the second direction, and connected to the first board, and a portion facing the through hole in the second direction of the end portion on one side in the first direction of the housing is positioned on another side in the first direction relative to an end portion on one side in the first direction of the through hole.
(2) The rotary electric machine according to (1), in which an end portion on one side in the first direction of the housing is positioned on the other side in the first direction from one side in the second direction toward the other side in the second direction, and a sealing material to seal between the cover and the housing is disposed between the cover and an end portion on one side in the first direction of the housing.
(3) The rotary electric machine according to (2), in which as viewed in a third direction orthogonal to both the first direction and the second direction, the end portion on one side in the first direction of the housing is linearly inclined.
(4) The rotary electric machine according to any one of (1) to (3), in which a portion facing the through hole in the second direction of the end portion on one side in the first direction of the housing is positioned on the other side in the first direction relative to the first terminal.
(5) The rotary electric machine according to any one of (1) to (4), further including a second board extending in a direction perpendicular or substantially perpendicular to the first direction and disposed on the other side in the first direction relative to the connector, in which the connector includes a second terminal connected to the second board, and the second board is fixed only to the lid and the housing.
(6) A manufacturing method of a rotary electric machine including a housing having a tubular shape extending in a first direction and including an opening that opens to one side in the first direction, a first board disposed on one side in a second direction intersecting the first direction relative to the housing, and a lid fixed to an end portion on one side in the first direction of the housing, in which the housing includes a through hole penetrating the housing in the second direction, the lid includes a connector including a first terminal and a holder to hold the first terminal, and a cover that covers the opening and formed using a same structure as that of the holder, the first terminal includes a first extending portion extending in the first direction and held by the holder, and a second extending portion extending in the second direction, passing through the through hole in the second direction, and connected to the first board, and a portion facing the through hole in the second direction of the end portion on one side in the first direction of the housing is positioned on another side in the first direction relative to an end portion on one side in the first direction of the through hole, the manufacturing method including a first process of moving the connector and the cover from another side in the second direction of the housing to one side in the second direction to pass the second extending portion through the through hole, and a second process of connecting the second extending portion to the first board.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotary electric machine comprising:
a housing having a tubular shape extending in a first direction and including an opening that opens to one side in the first direction;
a first board located on one side in a second direction intersecting the first direction with respect to the housing; and
a lid fixed to an end portion on one side in the first direction of the housing; wherein
the housing includes a through hole penetrating the housing in the second direction;
the lid includes:
a connector including a first terminal and a holder to hold the first terminal; and
a cover that covers the opening and defined by a same structure as that of the holder;
the first terminal includes:
a first extending portion extending in the first direction and held by the holder; and
a second extending portion extending in the second direction, passing through the through hole in the second direction, and connected to the first board; and
a portion opposing the through hole in the second direction of the end portion on one side in the first direction of the housing is positioned on another side in the first direction relative to an end portion on one side in the first direction of the through hole.

2. The rotary electric machine according to claim 1, wherein
an end portion on one side in the first direction of the housing is positioned on another side in the first direction from one side in the second direction toward the other side in the second direction; and
a sealing material to seal between the cover and the housing is located between the cover and an end portion on one side in the first direction of the housing.

3. The rotary electric machine according to claim 2, wherein as viewed in a third direction orthogonal to both the first direction and the second direction, the end portion on one side in the first direction of the housing is linearly inclined.

4. The rotary electric machine according to claim 1, wherein a portion opposing the through hole in the second direction of the end portion on one side in the first direction of the housing is positioned on another side in the first direction relative to the first terminal.

5. The rotary electric machine according to claim 1 further comprising:
a second board extending in a direction perpendicular or substantially perpendicular to the first direction and located on the other side in the first direction relative to the connector; wherein
the connector includes a second terminal connected to the second board; and
the second board is fixed only to the lid and the housing.

6. A manufacturing method of a rotary electric machine including:
a housing having a tubular shape extending in a first direction and including an opening that opens to one side in the first direction;
a first board located on one side in a second direction intersecting the first direction with respect to the housing; and
a lid fixed to an end portion on one side in the first direction of the housing; wherein
the housing includes a through hole penetrating the housing in the second direction;
the lid includes:
a connector including a first terminal and a holder to hold the first terminal; and
a cover that covers the opening and formed using a same structure as that of the holder;
the first terminal includes:
a first extending portion extending in the first direction and held by the holder; and
a second extending portion extending in the second direction, passed through the through hole in the second direction, and connected to the first board; and
a portion opposing the through hole in the second direction of the end portion on one side in the first direction of the housing is positioned on another side in the first direction relative to an end portion on one side in the first direction of the through hole;
the manufacturing method comprising:
a first process of moving the connector and the cover from another side in the second direction of the housing to one side in the second direction to pass the second extending portion through the through hole; and
a second process of connecting the second extending portion to the first board.
